(19) United States
(12) Patent Application Publication
(10) Pub. No.: US 2008/0140746 A1
(43) Pub. Date: Jun. 12, 2008

(54) Fast Quantum Mechanical Initial State Approximation

(75) Inventors: Anargyros Papageorgiou, New York, NY (US); Peter Jaksch, Norrkoping (SE)

Correspondence Address: WilmerHale/Columbia University, 399 PARK AVENUE, NEW YORK, NY, 10022, US

(73) Assignee: THE TRUSTEES OF COLUMBIA UNIVERSITY IN THE CITY OF NEW YORK, New York, NY (US)

(21) Appl. No.: 10/582,298

(22) PCT Filed: Feb. 4, 2004
(86) PCT No.: PCT/US04/03074

§ 371 Date: Sep. 18, 2007

Related U.S. Application Data
(60) Provisional application No. 60/529,780, filed on Dec. 15, 2003.

(51) Int. Cl. G06F 17/14

(52) U.S. Cl. 708/403

(57) ABSTRACT

A system and method efficiently prepare the initial state of q quantum computer required by the eigenvalue approximation method of Abrams and Lloyd. The system and method can be applied when solving continuous Hermitian eigenproblems, e.g. the Schrodinger equation, on a discrete gird, and allows for efficient calculation of their eigenvalues with quantum computers. A system and method efficiently prepare an approximate initial state (not limited to eigenvectors) of a quantum computer required by a quantum algorithm as input.

### GOVERNMENT INTERESTS

This application discloses an invention made with government support under Contract No. F30602-01-0523 awarded by US Air Force, Air Force Material Command Air Force Research Laboratory/IFKF. The government may have certain rights in the invention.

### FIELD OF THE INVENTION

This invention relates to quantum computing and to methods and systems to efficiently calculate eigenvalues and eigenvectors Hermitian operators and quantum mechanical evolution operators with quantum computers and methods and systems to efficiently calculate an approximate quantum state to be used as an input in a quantum mechanical system.

### BACKGROUND

Intuitively, quantum mechanical problems offer great potential for quantum computers to achieve large speedups over classical machines. An important problem of this kind is the approximation of an eigenvalue of a quantum mechanical operator. In a recent paper published in 1999 in Physical Review Letters (Vol 83, p. 5162) and hereby incorporated by reference, Abrams and Lloyd present a quantum method for doing this. Their method is exponentially faster than the best classical method, but requires a good approximation of the corresponding eigenvector as an input.

There is currently a continuing need for a method and system for efficiently computing a good approximation of the eigenvector as an input to the Abrams and Lloyd quantum method.

There is also a continuing need for a method and system for efficiently computing a good approximation of a quantum state (not limited to eigenvectors) as an input to a quantum mechanical computer or computation. For example, one would like to compute an approximate input to the quantum simulation algorithm. The quantum simulation algorithm is described in the book Quantum Computation and Quantum Information, by M. A. Nielsen and I. L. Chuang, Cambridge University Press, Cambridge UK (2000).

### SUMMARY OF THE INVENTION

The present invention is a system and method for use on a quantum computer to efficiently prepare the initial quantum state required by Abrams and Lloyd's eigenvalue approximation method. The system and method of the present invention is used to prepare a quantum register with an approximation of the eigenvector that is guaranteed to be sufficiently good to be used as input to the Abrams and Lloyd method. The present invention can be used when solving continuous Hermitian eigenproblems, e.g. the Schrodinger equation, on a discrete grid.

Beginning with an eigenvector for a problem discretized on a coarse grid, the system of the present invention efficiently constructs, quantum mechanically, an approximation of the same eigenvector on a finer grid. This eigenvector approximation is suitable as the initial state for the eigenvalue estimation method of Abrams and Lloyd.

Similarly beginning with a vector (i.e., a quantum state) for a continuous problem discretized on a coarse grid, the system of the present invention efficiently constructs, quantum mechanically, a vector (i.e., a state), which is an approximation to the corresponding vector on a finer grid. Our system efficiently extends a vector of low dimension to one of high dimension, which is then presented as input to some quantum computation method, e.g., the quantum simulation algorithm.

The features and advantages of the present invention will be more readily apparent and understood from the following detailed description of the invention, which should be understood in conjunction with the accompanying drawings appended to the end of the detailed description.

### BRIEF DESCRIPTION OF THE DRAWINGS

FIG. 1 is a chart illustrating the steps performed on the various quantum registers according to an embodiment of the present invention.

FIG. 2 is a chart illustrating the steps performed on the various quantum registers according to another embodiment of the invention.

### DETAILED DESCRIPTION

For purposes of illustration only, and not to limit the scope of the present invention, the invention will be explained with reference to the embodiments of the invention indicated in the drawings. One skilled in the art would understand that the present invention is not limited to the specific examples disclosed and can be more generally applied to other initial state preparation methods and systems than those disclosed.

The key component in the Abrams and Lloyd method is quantum phase estimation, which is a method for approximating an eigenvalue of a unitary matrix. Quantum phase estimation is also described in the above referenced book of Nielsen and Chuang. We give a brief outline of this method below.

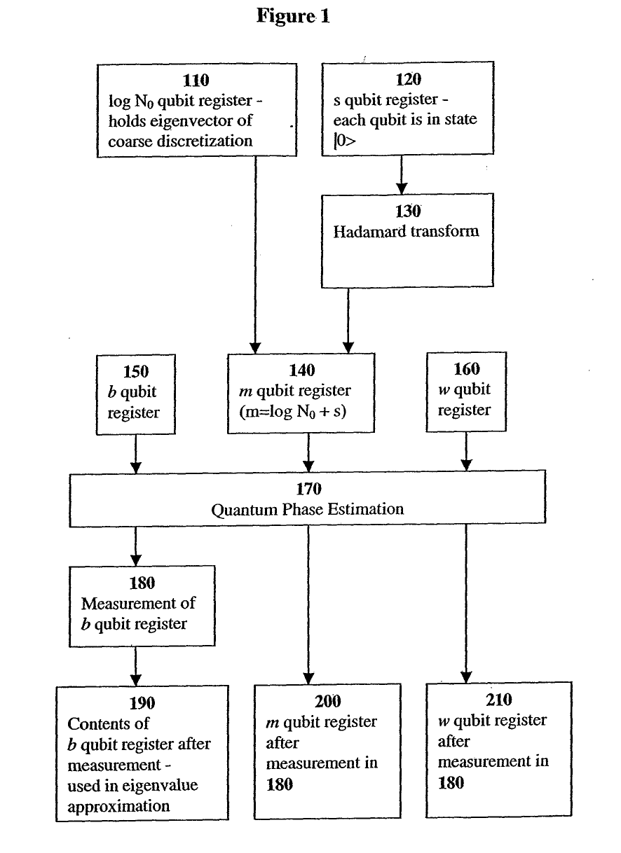

Let Q denote a 2^{m}×2^{m} unitary matrix. We want to approximate a specific eigenvalue of Q. Phase estimation does this using the corresponding eigenvector as input. The Abrams and Lloyd method deals with the case when this eigenvector is not known exactly. Referring to FIG. 1, consider a quantum computer consisting of three registers 140, 150, and 160 with a total of b+m+w qubits. The first b qubits in register 150 are all initially in the state |0 [symbol] . The second register 140 with m qubits is initialized to some state |ψ [symbol] , which must approximate the eigenvector in question sufficiently well, as will be seen. The last w qubits in register 160 are work qubits for temporary storage. The w qubits are not important in our discussion here, and we generally omit discussion of them below.

Since Q is unitary and therefore normal, the state |ψ [symbol] can be expanded with respect to eigenvectors of Q. Omitting discussion of the work qubits in register 160, the initial state of the algorithm is

$$\vert 0 \vert ψ = \text{\textbar} 0 {\sum }_{u} {d}_{u} \text{\textbar} u , \qquad ( 1 )$$

where |u [symbol] are the eigenvectors of Q. Placing the first register 150 in an equal superposition, using b Hadamard gates in step 170, transforms this state into

$$\frac{1}{\sqrt{{2}^{b}}} {\sum }_{j = 0}^{{2}^{b} - 1} \text{\textbar} j \qquad ( 2 )$$

Next, powers of Q are applied in step 170 to create the state

$$\frac{1}{\sqrt{{2}^{b}}} {\sum }_{j = 0}^{{2}^{b} - 1} \text{\textbar} j {Q}^{i} {\sum }_{u} {d}_{u} \text{\textbar} u . \qquad ( 3 )$$

Since Q is unitary, its eigenvalues can be written as e^{2πiφ}^{ᵤ}, where φᵤ∈R. We can assume that φᵤ∈[0,1) and consider the approximation of one of these phases instead of the approximation of one of the eigenvalues. Equation (3) is equal to

$$\frac{1}{\sqrt{{2}^{b}}} {\sum }_{u} {\sum }_{j = 0}^{{2}^{b} - 1} {d}_{u} {e}^{2 {πijϕ}_{u}} \text{\textbar} j \text{\textbar} u . \qquad ( 4 )$$

It is easily seen that the inverse Fourier transform performed in step 170 on the first register 150 creates the state

$$\begin{matrix}{\sum }_{u} {d}_{u} ( {\sum }_{j = 0}^{{2}^{b} - 1} g ( {ϕ}_{u} , j ) \text{\textbar} j ) \text{\textbar} u , \\ where & ( 5 ) \\ g ( {ϕ}_{u} , j ) = \{ \begin{matrix}\frac{sin ( π ( {2}^{b} {ϕ}_{u} - j ) ) {e}^{πi ( {ϕ}_{u} - j {2}^{- b} ) ( {2}^{b} - 1 )}}{{2}^{b} sin ( π ( {ϕ}_{u} - {j2}^{- b} ) )} , & {2}^{b} {ϕ}_{u} \neq j \\ 1 , & {2}^{b} {ϕ}_{u} = j .\end{matrix} & ( 6 )\end{matrix}$$

In step 180, a measurement of the first register 150 produces outcome j 190 with probability

$${p}_{j} = {\sum }_{u} {\vert {d}_{u} \vert}^{2} {\vert g ( {ϕ}_{u} , j ) \vert}^{2} , \qquad ( 7 )$$

and the second register 140 will collapse to the state

$${\sum }_{u} \frac{{d}_{u} g ( {ϕ}_{u} , j )}{\sqrt{{p}_{j}}} \text{\textbar} u . \qquad ( 8 )$$

represented by the register 200; register 210 contains the work qubits after the measurement 180 as known to one skilled in the art.

We remark that for special case when the eigenvalues φᵤ can be represented exactly with b-bits (i.e., 2^{b}φᵤ is an integer), equation (5) simplifies to

$${\sum }_{u} {d}_{u} \text{\textbar} {ϕ}_{u} \text{\textbar} u . \qquad ( 9 )$$

When the eigenvalues are of this form and are distinct, a measurement in step 180 of the first register 150 will cause the second register 140 to collapse exactly onto the corresponding eigenvector in register 200.

Recall that the system and method of the present invention are to achieve an approximation of the phase that corresponds to an eigenvector |u″ [symbol] using a quantum computer, that the state |ψ [symbol] is an approximation of this eigenvector, and that the eigenvalue is obtained from the value of the outcome j 190 by e^{2πij/2̂b} is of the form and approximates e^{2πiφ}^{ᵤ}. For instance, one is often interested in the eigenvalue corresponding to the ground state or in low order eigenvalues. We define Δ(φ₀, φ₁)=minₓ∈_{z}{|x+φ₁−φ₀|}, φ₀,φ₁∈R (i.e., the fractional part of the distance between φ₀ and φ₁) Then a measurement of the first register produces an outcome from the set G={j:Δ(j/2^{b}, φ_{u′})≦k/2^{b},k>1} with probability

$$\begin{matrix}Pr ( G ) = {\sum }_{j ∈ G} {\sum }_{u} {\vert {d}_{u} g ( {ϕ}_{u} , j ) \vert}^{2} \\ \geq {\sum }_{j ∈ G} {\vert {d}_{{u}^{′}} g ( {ϕ}_{{u}^{′}} , j ) \vert}^{2} \\ \geq {\vert {d}_{{u}^{′}} \vert}^{2} - \frac{{\vert {d}_{{u}^{′}} \vert}^{2}}{2 ( k - 1 )} ,\end{matrix} \qquad ( 10 )$$

and when k=1 the probability to obtain j such that Δ(j/2^{b}, φ_{u′})≦2^{-b} is bounded from below by

$$\frac{8}{{π}^{2}} {\vert {d}_{{u}^{′}} \vert}^{2} \cdot \vert ψ$$

must be chosen in a way that this probability is large or preferably greater than ½, which implies that |d_{u′}| has to be sufficiently large. For one embodiment of the present invention to obtain an approximation of φ_{u′} with accuracy 2⁻ⁿ and probability at least |d_{u′|}²(1−ε), equation (10) shows that the number of qubits b in the first register 150 must be

$$b = n + ⌈ log ( 1 + \frac{1}{2 ε} ) ⌉ . \qquad ( 11 )$$

Quantum phase estimation can be used as an efficient subroutine to find eigenvalues. Consider a Hermitian operator H. The operator G(t)=e^{-iHt} is unitary and has the same eigenvectors as H. We assume that G can be implemented efficiently and, therefore, can be used as the unitary operator in the phase estimation algorithm. For example, when H is local, i.e., it can be written in the form ΣHⱼ, where each Hⱼ acts only on a small number of qubits, then G can be implemented efficiently. However, locality is not a necessary condition for efficient implementation. Indeed, G can be efficiently implemented for a many-particle quantum mechanical system with a non-local H. One skilled in the art will understand that it is possible to implement G for a wide class of non-local Hamiltonians.

The Hermitian eigenproblem described above is solved on a discrete grid. One embodiment of the present invention addresses the case in which the grid is extremely fine. Clearly, a fine grid requires a large vector for the representation of the initial state of the algorithm. In general, it may not be possible to efficiently prepare an arbitrary quantum state in a space with a large number of qubits. However, the present invention includes a method for the efficient preparation of an initial state.

In one embodiment of the invention, the operator possesses an eigenvector for a coarse grid discretization of the problem, which was most likely obtained classically since the size of the problem is small, although one skilled in the art will understand an eigenvector obtained by any coarse method can be employed without diverging from the scope of the invention. Using this eigenvector, we efficiently construct an approximation to the corresponding eigenvector for a fine grid discretization of the problem. We use this approximation as the initial state of the eigenvalue approximation algorithm. We describe our method for a one-dimensional continuous problem on the interval [0,1].

Let H be a positive Hermitian operator, defined on a Hilbert space of smooth functions on [0,1]. Let vₖ(·), k=1,2, . . . , denote the eigenfunctions of H, ordered according to the magnitude of the corresponding eigenvalues; and without loss of generality we assume that

$${\int }_{0}^{1} {\vert {v}_{k} ( x ) \vert}^{2} d x = 1. \qquad ( 12 )$$

Suppose that H_{N} is a discretization of H with grid size h_{N}=1/(1+N). Let |Uₖ^{(N)} [symbol] k=0,1, . . . ,N−1, denote the normalized eigenvectors of H_{N}, ordered according to the magnitude of the corresponding eigenvalues. The expansion of the k-th eigenvector in the computational basis can be written as

$$\text{\textbar} {U}_{k}^{( N )} = {\sum }_{j = 0}^{N - 1} {u}_{k , j}^{( N )} \text{\textbar} j . \qquad ( 13 )$$

$$Let \vert {V}_{k}^{( N )} = {\sum }_{j = 0}^{N - 1} {v}_{k} ( ( j + 1 ) {h}_{N} ) \vert j$$

be the sampled version of vₖ(·) at the discretization points. Consider problems such that the eigenvector of interest satisfies ∥v′ₖ∥_{∞}=sup_{0≦x≦1}|v′ₖ(x)|=O(1) and

$$‖ \text{\textbar} {U}_{k}^{( N )} - \frac{\text{\textbar} {V}_{k}^{( N )} }{‖ \text{\textbar} {V}_{k}^{( N )} ‖} ‖ = O ( {h}_{N}^{g} ) , \qquad ( 14 )$$

where q>0 is the order of convergence and

$${‖ \text{\textbar} X ‖}^{2} = {\sum }_{j = 0}^{N - 1} {\vert {x}_{j} \vert}^{2} for \text{\textbar} X = {\sum }_{j = 0}^{j = N - 1} {x}_{j} \text{\textbar} j . \qquad$$

for

$$\vert X = {\sum }_{j = 0}^{j = N - 1} {x}_{j} \vert j .$$

For example, these conditions are satisfied when, for example, we are dealing with second order elliptic operators.

Now, assume that the eigenvector |Uₖ^{(N}^{₀}⁾ [symbol] of H_{N}_{₀} has been obtained classically. This vector is placed in a log NO qubit register 110 (see FIG. 1). For N=2^{s}N₀, we construct an approximation |Ũₖ^{(N)} [symbol] of |Uₖ^{(N)} [symbol] by appending s qubits in register 120, each qubit in the state |0 [symbol] , to |Uₖ^{(N)} [symbol] and then performing in step 130 a Hadamard transformation on each one of these s qubits in register 120, i.e.

$$\text{\textbar} {\tilde{U}}_{k}^{( N )} = \text{\textbar} {\tilde{U}}_{k}^{( {N}_{0} )} {( \frac{\text{\textbar} 0 + \text{\textbar} 1 }{\sqrt{2}} )}^{⊗ s} = \frac{1}{\sqrt{{2}^{s}}} {\sum }_{j = 0}^{N - 1} {u}_{k , j ( i )}^{( {N}_{0} )} \text{\textbar} j , \qquad ( 15 )$$

where ƒ(j)=└j/2^{s}┘. The effect of ƒ is to replicate the coordinates of |Uₖ^{(N}^{₀}⁾ [symbol] 2^{s} times. According to the present invention, |Ũₖ^{(N)} [symbol] is used as input to the eigenvalue and eigenvector approximation method. When the result of the method is measured |Ũₖ^{(N)} [symbol] will collapse onto a superposition of eigenvectors according to equation (8). The magnitude of the coefficient of |Uₖ^{(N)} [symbol] in this superposition can be made arbitrarily close to one by appropriately choosing N₀.

Consider two different expansions of |Ũₖ^{(N)} [symbol] :

$$\begin{matrix}\text{\textbar} {\tilde{U}}_{k}^{( N )} = {\sum }_{j = 0}^{N - 1} {u}_{k , j}^{( N )} \text{\textbar} j & ( 16 ) \\ \text{\textbar} {\tilde{U}}_{k}^{( N )} = {\sum }_{j = 0}^{N - 1} {d}_{k , l}^{( N )} \text{\textbar} {\tilde{U}}_{l}^{( N )} . & ( 17 )\end{matrix}$$

The first expansion is in the computational basis and the second is with respect to the eigenvectors H_{N}. We call |d_{k,k}^{(N)}|² the probability of success. Equation (17) can be rewritten as

$$\text{\textbar} {\tilde{U}}_{k}^{( N )} - \text{\textbar} {U}_{k}^{( N )} = ( {d}_{k , k}^{( N )} - 1 ) \text{\textbar} {\tilde{U}}_{k}^{( N )} + {\sum }_{l \neq k} {d}_{k , l}^{( N )} \text{\textbar} {U}_{l}^{( N )} . \qquad ( 18 )$$

Taking norms on both sides and using (13) and (16) gives the inequality

$$\begin{matrix}{‖ \text{\textbar} {U}_{k}^{( N )} - \text{\textbar} {\tilde{U}}_{k}^{( N )} ‖}^{2} = {\sum }_{j = 0}^{N - r} {\vert {u}_{k , j}^{( N )} - {\tilde{u}}_{k , j}^{( N )} \vert}^{2} \\ = {\vert {d}_{k , k}^{( N )} - 1 \vert}^{2} + {\sum }_{l \neq k} {\vert {d}_{k , l}^{( N )} \vert}^{2} \\ \geq {\sum }_{l \neq k} {\vert {d}_{k , l}^{( N )} \vert}^{2} \\ = 1 - {\vert {d}_{k , k}^{( N )} \vert}^{2} .\end{matrix} \qquad ( 19 )$$

We will now bound (19) from above, and thus the probability of failure. The definition of |Ũₖ^{(N)} [symbol] implies

$${‖ \text{\textbar} {U}_{k}^{( N )} - \text{\textbar} {\tilde{U}}_{k}^{( N )} ‖}^{2} = {\sum }_{j = 0}^{N - 1} {\vert \begin{matrix}\frac{{v}_{k} ( ( j + 1 ) {h}_{N} )}{‖ \vert {V}_{k}^{( N )} ‖} - \\ \frac{{v}_{k} ( ( f ( j ) + 1 ) {h}_{{N}_{0}} )}{\text{?} ‖ \vert {V}_{k}^{( {N}_{0} )} 〉 ‖} + \\ {Δ}_{k , j}^{( N )} - \frac{{Δ}_{k , f ( j )}^{( {N}_{0} )}}{\text{?}}\end{matrix} \vert}^{2} , \\ \text{?} \text{indicates text missing or illegible when filed} \qquad ( 20 )$$

where

$${\sum }_{j = 0}^{N - 1} {\vert {Δ}_{k , j}^{( N )} \vert}^{2} = O ( {h}_{N}^{2 q} ) and {\sum }_{j = 0}^{N - 1} {\vert {Δ}_{k , f ( j )}^{( {N}_{0} )} \vert}^{2} = {2}^{s} O ( {h}_{{N}_{0}}^{2 q} ) by ( 14 ) .$$

Applying the triangle inequality, we get

$$‖ \text{\textbar} {U}_{k}^{( N )} - \text{\textbar} {\tilde{U}}_{k}^{( N )} ‖ \leq {( {\sum }_{j = 0}^{N - 1} {\vert \begin{matrix}\frac{{v}_{k} ( ( j + 1 ) {h}_{N} )}{‖ \vert {V}_{k}^{( N )} ‖} - \\ \frac{{v}_{k} ( ( f ( j ) + 1 ) {h}_{{N}_{0}} )}{\text{?} ‖ \vert {V}_{k}^{( {N}_{0} )} 〉 ‖}\end{matrix} \vert}^{2} )}^{1 / 2} + O ( {h}_{{N}_{0}}^{q} ) . \\ \text{?} \text{indicates text missing or illegible when filed} \qquad ( 21 )$$

The definition of |Vₖ^{(N)} [symbol] and the fact that ∥v′ₖ∥_{∞}=O(1) imply that ∥Vₖ^{(N)} [symbol] ∥=\sqrt{N}(1+O(h_{N})). Hence, the sum above is equal to

$$\frac{1}{N} {\sum }_{j = 0}^{N - 1} {\vert \begin{matrix}{v}_{k} ( ( j + 1 ) {h}_{N} ) ( 1 + O ( {h}_{N} ) ) - \\ {v}_{k} ( ( f ( j ) + 1 ) {h}_{{N}_{0}} ) ( 1 + O ( {h}_{{N}_{0}} ) )\end{matrix} \vert}^{2} . \qquad ( 22 )$$

Since vₖ(·) is continuous with a bounded first derivative, we have that

uₖ(x_{2,j})=uₖ(x_{1,j})+O(|x_{2,j}−x_{1,j}|), (123)

where x_{1,j}=(j+1)h_{N} and x_{2,j}=(ƒ(j)+1)h_{N}_{₀},j=0, . . . ,N−1. Clearly |x_{2,j}−x_{1,j}|=O(h_{N}_{₀}). Using (22), (23) and the triangle inequality, we obtain from (21) that

$$\begin{matrix}{‖ \text{\textbar} {U}_{k}^{( N )} - \text{\textbar} {\tilde{U}}_{k}^{( N )} ‖}^{2} \leq O ( {h}_{{N}_{0}} ) \frac{‖ \text{\textbar} {V}_{k}^{( N )} ‖}{\sqrt{N}} + \\ O ( {h}_{{N}_{0}} ) + O ( {h}_{{N}_{0}} ) = O ( {h}_{{N}_{0}}^{min \{ 1 , q \}} ) .\end{matrix} \qquad ( 24 )$$

Hence, the probability of failure is bounded from above by O(N₀^{-min{2,2q}}). It depends only on the order of convergence to the continuous problem and the number of points in the classically solved small problem. We can select an N₀ such that the probability of failure is less than ½, no matter how much larger N is. By choosing a large N, we can make the discretization error arbitrarily small. Equation (24) implies that the probability of obtaining the eigenvalue e^{2πiφ}^{ₖ} with accuracy 2^{-b} is at least

$$\frac{8}{{π}^{2}} ( 1 - O ( {N}_{0}^{- min \{ 2 , 2 q \}} ) ) .$$

We remark that any classical numerical algorithm that computes an eigenvalue, satisfying a specific (nontrivial) property, of a N×N unitary matrix takes time Ω(N). For example, one may want to find the eigenvalue that corresponds to the ground state. This is true even if a matrix is sparse and regardless of whether the algorithm is deterministic or randomized. It is merely a consequence of the fact that the algorithm needs to consider all the (nonzero) elements of the matrix, and there are at least Ω(N) such elements. Alternatively, in the restricted case when the matrix is diagonal finding one of its elements is a problem at least as hard as searching an unordered list. The lower bound for searching yields the lower bound in our case.

In conclusion, our method provides a highly efficient preparation of initial states for eigenvalue approximation, requiring only a small number of Hadamard gates. Thus the method of Abrams and Lloyd, using the initial state prepared by the system and method of the present invention, computes the eigenvalue exponentially faster than any classical algorithm. The method of the invention can be generalized to higher dimensional continuous problems.

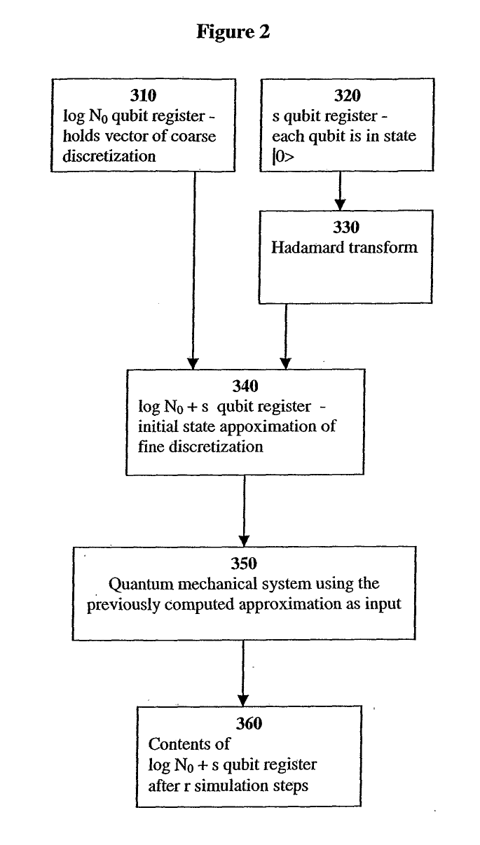

In another embodiment of the invention, if we possess a vector that corresponds to a coarse discetization of a continuous problem then, under suitable conditions, we can efficiently extend it to a vector that approximates the corresponding vector (i.e., a state) of a fine discretization. Referring to FIG. 2, we first place the original or given vector in register 310. Assuming that the vector has dimension N₀ this register has log N₀ qubits. For a N=2^{s}N₀, we append to register 310 s qubits, in the state |0 [symbol] , in register 320. Then in step 330 we apply the Hadamard transform to the appended qubits. See Equation (15) and the explanation of the effect of the replicating function ƒ. In register 340 we have the combination of the two registers 310, 320, register 340 containing the approximation corresponding to a vector (i.e., state) of dimension N=2^{s}N₀. This requires log N=log N₀+s qubits for its quantum mechanical representation. Step 350 represents a quantum mechanical system using the approximation obtained in register 340. Step 360 represents the final state of the system 350.

Having described the embodiments of the invention, it should be apparent that various combinations of embodiments may be made or modifications added thereto as is known to those skilled in the art without departing from the spirit and scope of the invention.

We claim:

1. A method for preparing a quantum state as an input to a quantum computer computation, said method comprising:
preparing a quantum state as an input to a quantum computer computation, wherein said preparing a quantum state includes performing a Hadamard transformation on at least one qubit.

2. A method for computing an approximation of a vector, comprising:
storing a first approximation in a quantum computer register; and
appending a qubit to the register.

3. The method as recited in claim 2, further comprising:
performing a Hadamard transformation on the appended qubit.

4. A method for preparing the initial state of a quantum computer, comprising:
preparing the initial state of a quantum computer, wherein said preparation includes performing a Hadamard transformation.

5. The method as recited in claim 4, wherein said preparation further includes:
storing a vector in a quantum computer register; and
appending at least two qubits to the vector.

6. The method as recited in claim 5, wherein:
at least two of the appended qubits are in the state |0 [symbol] .

7. The method as recited in claim 6, wherein:
the Hadamard transformation is performed on the appended qubits.

8. A method for efficiently preparing the initial state of a quantum computer required by the quantum method for eigenvalue approximation of Abrams and Lloyd, said method comprising the steps of:
storing a first eigenvector approximation in a quantum computer register;
appending at least two qubits in the state 10) to the first eigenvector approximation; and
performing a Hadamard transformation on the appended qubits.

9. A method for efficiently preparing an initial state of a quantum computer for eigenvalue approximation, comprising:
obtaining a first eigenvector;
placing the eigenvector in a quantum computer register;
appending at least two qubits to the register; and
performing a Hadamard transformation on each of the at least two qubits.

10. The method as recited in claim 9, wherein the at least two qubits are in the state |0 [symbol] .

11. The method as recited in claim 10, wherein said first eigenvector approximation is obtained for an eigenproblem discretized on a coarse grid.

12. The method as recited in claim 11, further comprising using the qubit register after the Hadamard transformation as input to the Abrams and Lloyd quantum method.

13. A method for approximating an eigenvalue of an eigenproblem with a quantum computer, comprising:
obtaining a first eigenvector from a course discretization of the eigenproblem;
storing the first eigenvector in a quantum register of size log N₀ qubits;
appending at least two qubits in a second quantum register to the first eigenvector, wherein the at least two qubits are in the state |0 [symbol] ;
performing a Hadamard transformation on each of the at least two qubits to derive a second eigenvector; and
using the second eigenvector in the Abrams and Lloyd quantum method.

14. The method as recited in claim 13, wherein the first eigenvector is obtained classically.

15. A quantum computing system for computing an eigenvalue, comprising: means for storing a first eigenvector in a quantum register;
means for appending at least two qubits to the first eigenvector in the quantum register; and
means for performing a Hadamard transformation on each of the at least two qubits.

16. A quantum computing system as recited in claim 15, wherein said additional qubits are appended while in a predetermined state.

17. A quantum computing system as recited in claim 16, wherein the predetermined state is the state |0 [symbol] .

18. A quantum computing system, comprising:
a first quantum register with size of at least log N₀ qubits, able to store an eigenvector;
means for appending at least two qubits in a second quantum register, each of the at least two qubits in the state |0 [symbol] , to the eigenvector; and
means for performing a Hadamard transformation on each of the at least two qubits.

19. The quantum computing system as recited in claim 18, wherein:
the eigenvector is derived from an eigenproblem discretized on a coarse grid.

20. The quantum computing system as recited in claim 19, further comprising:
means to use the eigenvector as input to the Abrams and Lloyd quantum method; and
a module stored on magnetic media.
